(19) United States
(12) Patent Application Publication
(10) Pub. No.: US 2005/0207739 A1
(43) Pub. Date: Sep. 22, 2005

(54) Content transmitting apparatus, content receiving apparatus, content transmitting and receiving system, content transmitting method, and content receiving method

(75) Inventor: Hiroyuki Kamio, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/062,473

(22) Filed: Feb. 22, 2005

(30) Foreign Application Priority Data
Mar. 16, 2004 (JP) 2004-075053

(51) Int. Cl. H04N 5/781

(52) U.S. Cl. 386/125; 386/126

(57) ABSTRACT

A video recording and reproducing apparatus on a transmitting side encodes video and audio content into MPEG data. The video recording and reproducing apparatus then divides the MPEG data into an MPEG stream and reference information thereof, records the MPEG stream and the reference information in a recording medium in the DVD-VR format, and transmits the content in the DVD-VR format via a network. A transmitting section of the recording and reproducing apparatus transmits the MPEG stream in an M_VOB and reference information of the MPEG stream. The reference information includes VOBU_ENT information for all VOBUs contained in the M_VOB, M_VOB_STI information of the M_VOB, and start and end PTM information of the M_VOB. Thus, content recorded in one video recording and reproducing apparatus is copied to another video recording and reproducing apparatus via a network.

### CROSS-REFERENCE TO RELATED APPLICATIONS

This application is based upon and claims the benefit of priority from the prior Japanese Patent Application No. 2004-75053 filed on Mar. 16, 2004; the entire contents of which are incorporated herein by reference.

### BACKGROUND OF THE INVENTION

1. Field of the Invention

The present invention relates to a content transmitting apparatus, a content receiving apparatus, a content transmitting and receiving system, a content transmitting method, and a content receiving method, all of which as a whole can record content recorded in a video recording and reproducing apparatus on the transmitting side in a video recording and reproducing apparatus on the receiving side via a network.

2. Description of the Related Art

A known technology, for example, Japanese Unexamined Patent Application Publication No. 2002-150672 discloses a technology in which a video recording and reproducing apparatus has two recording media of a DVD-RAM, that is, an optical disk, and a hard disk (HD), that is, a magnetic disk, and content is copied (dubbed) between the two media in a short time while checking for unauthorized copy protection.

However, Japanese Unexamined Patent Application Publication No. 2002-150672 does not disclose that content recorded in a recording and reproducing apparatus is copied to another recording and reproducing apparatus via a network.

### BRIEF SUMMARY OF THE INVENTION

Accordingly, it is an object of the present invention to provide a content transmitting apparatus, content receiving apparatus, content transmitting and receiving system, content transmitting method, and content receiving method, all of which as a whole can copy content recorded in one video recording and reproducing apparatus to another video recording and reproducing apparatus via a network.

According to an aspect of the present invention, a content transmitting apparatus includes a section for supplying video and audio content, a section for encoding the supplied content into MPEG data, a section for dividing the MPEG data into an MPEG stream and reference information thereof and recording the MPEG stream and the reference information in a recording medium in the DVD-VR format, and a transmitting section for transmitting the content in the DVD-VR format via a network. The transmitting section transmits the MPEG stream in an M_VOB and reference information of the MPEG stream, wherein the reference information includes VOBU_ENT information for all VOBUs contained in the M_VOB, M_VOB_STI information of the M_VOB, and start and end PTM information of the M_VOB.

Preferably, in the content transmitting apparatus, the reference information further includes one of CI start and end PTMs, SMLI and AGAPI information of the M_VOB, and both of the CI start and end PTMs and the SMLI and AGAPI information of the M_VOB.

According to another aspect of the present invention, a content receiving apparatus includes a receiving section for receiving a stream transmitted by the above-described content transmitting apparatus via a network and a section for reconstructing content in the DVD-VR format from the received stream and recording the content in a recording medium. An MPEG stream in the M_VOB of the received stream is recorded in a VRO data file. IFO information is created from reference information in the received stream and is recorded in an IFO file, and the reference information includes VOBU_ENT information for all VOBUs contained in the M_VOB, M_VOB_STI information of the M_VOB, and start and end PTM information of the M_VOB.

According to still another aspect of the present invention, a content transmitting and receiving system includes a content transmitting apparatus and a content receiving apparatus. The content transmitting apparatus includes a section for supplying video and audio content, a section for encoding the supplied content into MPEG data, a section for dividing the MPEG data into an MPEG stream and reference information thereof and recording the MPEG stream and the reference information in a recording medium in the DVD-VR format, and a transmitting section for transmitting the content recorded in the DVD-VR format via a network. The transmitting section transmits an MPEG stream in M_VOB and reference information of the MPEG stream, and the reference information includes VOBU_ENT information for all VOBUs contained in the M_VOB, M_VOB_STI information of the M_VOB, and start and end PTM information of the M_VOB. The content receiving apparatus includes a receiving section for receiving a stream transmitted by the content transmitting apparatus via a network and a section for reconstructing the content in the DVD-VR format from the received stream and recording the content in a recording medium. An MPEG stream in the M_VOB of the received stream is recorded in a VRO data file. IFO information is created from the reference information in the received stream and is recorded in an IFO file.

According to another aspect of the present invention, a content transmitting method comprising: the steps of supplying video and audio content, encoding the supplied content into MPEG data, dividing the MPEG data into an MPEG stream and reference information thereof and recording the MPEG stream and the reference information in a recording medium in the DVD-VR format, and transmitting the content in the DVD-VR format via a network. The transmitting step transmits the MPEG stream in an M_VOB and reference information of the MPEG stream, and the reference information includes VOBU_ENT information for all VOBUs contained in the M_VOB, M_VOB_STI information of the M_VOB, and start and end PTM information of the M_VOB.

According to another aspect of the present invention, a content receiving method comprising: the steps of receiving a stream transmitted via a network by the above-described transmitting method and recording, in a recording medium, a reconstructed stream as content in the DVD-VR format. An MPEG stream in the M_VOB of the received stream is recorded in a VRO data file. IFO information is created from reference information in the received stream and is recorded in an IFO file. The reference information includes VOBU_ENT information for all VOBUs contained in the M_VOB, M_VOB_STI information of the M_VOB, and start and end PTM information of the M_VOB.

As described above, according to the present invention, a content transmitting apparatus can transmit an MPEG stream in the DVD-VR format to a network and a content receiving apparatus can record or copy the MPEG stream thereto.

In the known technologies, the reference information can be transmitted along with the MPEG stream only within a single apparatus. According to the present invention, an apparatus on the transmitting side can transmit the reference information to an apparatus on the receiving side via a network, thus allowing content to be copied among a plurality of apparatuses.

### BRIEF DESCRIPTION OF THE DRAWINGS

FIG. 1 is a schematic block diagram of a video recording and reproducing apparatus according to an embodiment of the present invention;

FIG. 2 is a diagram of the logical structure of content in the DVD-VR format;

FIG. 3 illustrates a structure of an MPEG stream transmitted from the video recording and reproducing apparatus to a network via an Ethernet (trademark) controller according to the embodiment of the present invention;

FIG. 4 is a diagram illustrating PGI header information of the transmitted stream shown in FIG. 3;

FIG. 5 is a diagram illustrating VOB header information of the transmitted stream shown in FIG. 3;

FIG. 6 is a flow chart of a process of converting content from the DVD-VR format to the transmission stream format shown in FIG. 3 according to the present invention; and

FIG. 7 is a flow chart for a video recording and reproducing apparatus that receives the transmission stream shown in FIG. 3 to reconstruct the content in the DVR-VR format from the transmission stream according to the present invention.

### DETAILED DESCRIPTION OF THE INVENTION

Embodiments of the present invention will be described below with reference to the accompanying drawings.

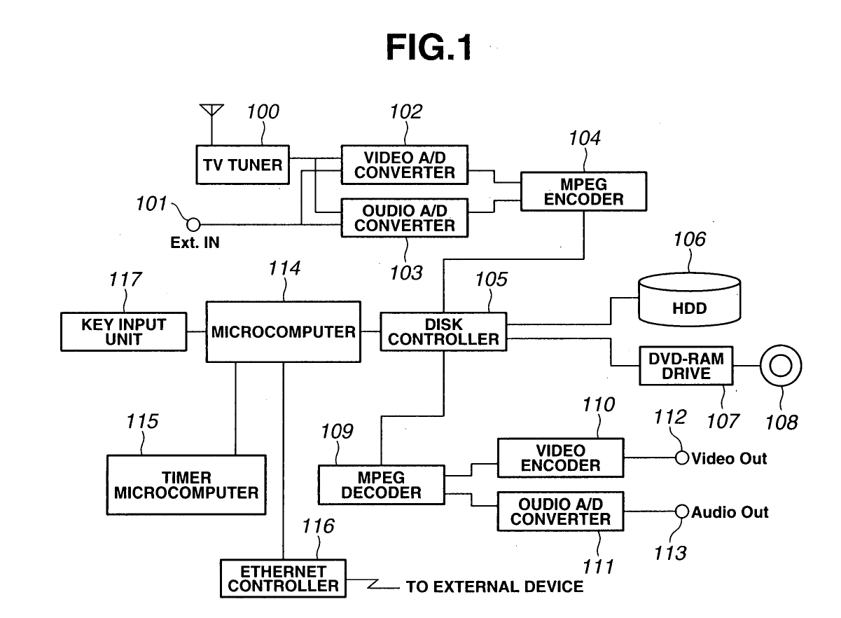

FIG. 1 is a schematic block diagram of a video recording and reproducing apparatus according to an embodiment of the present invention. The video recording and reproducing apparatus in FIG. 1 also functions as a transmitter and a receiver by using an Ethernet (trademark) controller 116.

As shown in FIG. 1, the video recording and reproducing apparatus includes a television tuner 100 (hereinafter referred to as a TV tuner 100), an external input terminal (Ext. IN) 101, a video A/D converter 102, an audio A/D converter 103, an MPEG encoder 104, a disk controller 105, a hard disk drive (HDD) 106 having a hard disk therein as a recording medium, a DVD-RAM drive 107 having a DVD-RAM disk 108 therein as a recording medium, an MPEG decoder 109, a video encoder 110, an audio D/A converter 111, a video signal output terminal 112, an audio signal output terminal 113, a microcomputer 114 functioning as a control section, a timer microcomputer 115, the Ethernet (trademark) controller 116 functioning as a communication section, and a key input unit 117 functioning as an operation section.

The TV tuner 100 receives a television broadcasting signal input from an antenna and demodulates analog video and audio signals. The TV tuner 100 or an external video device (not shown) connected to the external input terminal (Ext. IN) 101 serves as a supplying section of content using video and audio signals.

The video A/D converter 102 and the audio A/D converter 103 convert the demodulated video and audio signals to digital signals and also convert video and audio signals input from the external input terminal (Ext. In) 101 to digital signals, and then output them to the MPEG encoder 104.

The MPEG encoder 104 encodes the digitally converted video and audio signals into an MPEG compressed format and outputs them to the disk controller 105.

The disk controller 105 records the video and audio signals in an MPEG compressed format (hereinafter also referred to as “MPEG data”) on the hard disk, having a predetermined capacity, in the HDD 106 or on the DVD-RAM disk 108 detachably mounted in and driven by the DVD-RAM drive 107. The disk controller 105 then generates recording data having a file structure based on the DVD-VR standard. At playback time, the disk controller 105 drives the HDD 106 and the DVD-RAM drive 107 to reproduce the recorded data from the hard disk and the DVD-RAM disk 108.

At playback time, the MPEG decoder 109 decodes MPEG data read out from the hard disk and the DVD-RAM disk 108 by the disk controller 105. That is, the MPEG decoder 109 decompresses and decodes the MPEG data.

The video encoder 110 D/A converts video data decompressed and decoded from the MPEG data to encode the video data to television video signals, such as signals in the NTSC format, and outputs them. The audio D/A converter 111 D/A converts audio data decompressed and decoded from the MPEG data and outputs it.

The video signal output terminal 112 outputs the encoded video signal output “Video Out” to an external device (not shown), while the audio signal output terminal 113 outputs the D/A converted audio signal output “Audio Out” to the external device (not shown).

The microcomputer 114 includes a central processing unit (CPU) for carrying out arithmetic operations, a read only memory (ROM) for storing data of a control program, and a random access memory (RAM) functioning as a data area and a work area. The microcomputer 114 provides a function to carry out various processes for controlling the entire apparatus, such as control of recording to and reproducing from the disk controller 105 and control of transmission to and reception from the Ethernet (trademark) controller 116 based on inputs from the key input unit 117. The timer microcomputer 115 is controlled by the microcomputer 114 so as to carry out time measurement and timer setting for recording and reproducing programs.

The Ethernet (trademark) controller 116 is controlled by the microcomputer 114 so as to function as a communication (transmission and reception) section for carrying out communication with external devices and a personal computer (PC) over a physical layer of the Ethernet (trademark).

The key input unit 117 includes buttons mounted on an operation panel of the recording and reproducing apparatus or a remote-control transmission device. By operating keys, a user can determine a selection item, can select a TV channel, and can set a timer for recording and reproducing programs.

The recording and reproducing apparatus shown in FIG. 1 includes the DVD-RAM drive 107, which is an optical disk drive unit, and the HDD 106, which is a magnetic disk unit. The recording and reproducing apparatus records video signals input from the TV tuner 100 and the external input terminal 101 on each recording medium, that is, on the DVD-RAM disk or the hard disk. The video signals are recorded in the DVD-RAM disk 108 mounted in the DVD-RAM drive 107 in the DVD Video Recording (DVD-VR) format defined by the DVD Forum. On the other hand, the video signals are recorded on the hard disk of the HDD 106 in the expanded DVD-VR format for an HDD. However, in this embodiment, the video signals are recorded in the DVD-VR format for both the DVD-RAM disk 108 and the hard disk. As described above, the recording and reproducing apparatus includes the Ethernet (trademark) controller 116 for allowing communication (transmission and reception) with external devices and personal computers (PCs) connected via the Ethernet (trademark) under the control of the microcomputer 114.

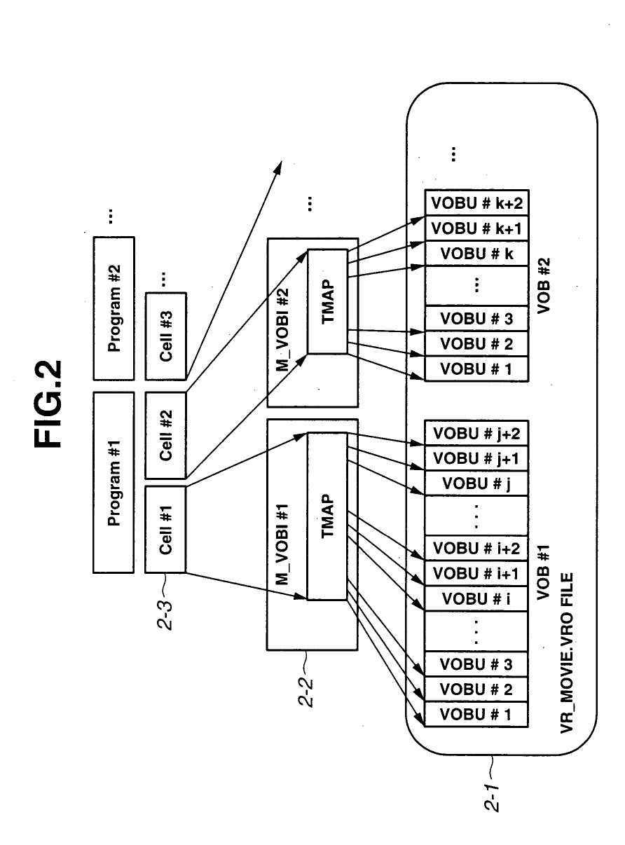

FIG. 2 illustrates a logical structure of content in the DVD-VR format. In the DVD-VR format, video signals of moving images are compressed into an MPEG stream, which is stored in a VRO file named VR_MOVIE.VRO, designated by reference numeral 2-1, on a recording medium (hereinafter referred to as a disk or a medium), for example, a hard disk. Management information, such as a logical structure thereof, is stored in an IFO file named VR_MANGR.IFO.

Only one VR_MANGR.IFO file resides in a disk. For example, when a plurality of TV programs is recorded in the file, a new program is recorded after the last recorded program. A continuous MPEG stream which records a program is referred to as a video object (VOB). Since this is a VOB of moving images, the VOB is referred to as a movie VOB (M_VOB). That is, M_VOB refers to MPEG data of moving images. The VR_MOVIE.VRO file is a set of a plurality of M_VOBs.

The management information about the M_VOB is stored in a movie VOB information (M_VOBI) table, shown by reference numeral 2-2, in the VR_MANGR.IFO file on the disk. In the M_VOBI, a presentation time (PTM), which is a time stamp including a start point and an end point of the M_VOB, and audio and video attributes of the M_VOB are recorded. The M_VOB is a continuous MPEG stream, which consists of a group of pictures (GOP). This GOP is referred to as a VOB unit (VOBU). That is, the VOBU is the name of the GOP in the DVD-VR standard and is a minimum unit of the VOB. In general, the VOBU consists of one GOP. However, the VOBU may consist of a plurality of GOPs as long as the VOBU is in the range of 0.4 to 1 second. In the above-described M_VOBI, VOBU_ENT information about the VOBU, e.g., a VOBU size, the size of a first I-Picture in the VOBU, and a VOBU reproducing time, and TM_ENT information for a time-search reproduction are recorded. These two types of information, that is, the VOBU_ENT information and TM_ENT information, are referred to as TMAP information as a generic term. Only reference information is extracted from the VOBU to generate the VOBU_ENT information, which is management information required for reproducing.

On the other hand, content recorded on a disk is presented to users as a program. A program does not necessarily correspond to an M_VOBI on a one-to-one basis. One program may correspond to a plurality of M_VOBIs. A cell designated by reference numeral 2-3 associates a program with an M_VOBI. The cell is used for defining partial MPEG data to be reproduced. For example, for MPEG data containing a commercial message (CM), a reproducing area without the CM is referred to as a cell. A start time and an end time (PTM) of the cell are specified in cell information (CI).

The entire MPEG data between the start point and the end point is a VOB. If, for example, the time duration of the VOB is in the range of 0 and 100 seconds, a cell must be longer than or equal to a value between 2 seconds, the minimum value, and 98 seconds. That is, in the DVD-VR specification, the cell must have less than 2 seconds before and after the cell. In other words, since one GOP is 0.5 seconds long, the cell must have less than 4 GOPs before and after the cell. In the case of removing CMs, an MPEG image is only edited on a GOP basis, which is 0.5 seconds long. The cell allows the image to be edited on a frame basis, which is, for example, 1/30 seconds long. Accordingly, specifying a cell allows a small amount of time editing (adjustment). That is, by using a cell, a drawback that a small amount at the end of the CM cannot be removed in CM removal can be eliminated. Each cell records therein a start PTM and an end PTM of the corresponding M_VOBI, and a program can have a plurality of cells.

In a known technology, a video recording and reproducing apparatus having two recording media, that is, a DVD-RAM disk and a hard disk, as shown in FIG. 1, copies a program from one recording medium to the other recording medium by adding management information (IFO information), such as a program, a cell, and an M_VOBI, to the medium to be dubbed and then copying an MPEG stream. That is, the IFO information and the MPEG stream are separately transmitted to record them into the corresponding files.

On the other hand, when content is copied from a video recording and reproducing apparatus to another video recording and reproducing apparatus via a network using the Ethernet (trademark) controller 116, both the IFO information and the MPEG stream must also be transmitted. In this case, since TMAP information in the M_VOBI of IFO information is closely related to an MPEG stream, the consistency between the M_VOBI and the MPEG stream must be maintained. Additionally, when content is copied on a program basis via a network, a plurality of reference information items must be transmitted in addition to the M_VOBI and VOBU_ENT information.

When a connected apparatus is a PC on a network and content is reproduced using MPEG reproducing software on the PC (e.g., Windows Media Player (trademark)), a problem may possibly occur depending on a position where IFO information is added. That is, Windows Media Player (trademark) pre-reads a head portion of a reproducing file in order to detect the type of the file to prepare for reproduction. Therefore, if the IFO information, which is not MPEG data, is added to the head of the file, Windows Media Player (trademark) cannot reproduce the content, which is a problem.

To solve the problem, according to an embodiment of the present invention, a section for converting content recorded in the DVD-VR format to the following stream format and a section for reconstructing the content in the stream format to the DVD-VR format are provided. These sections allow content recorded in the DVD-VR format to be copied among apparatuses that can communicate with each other over a network.

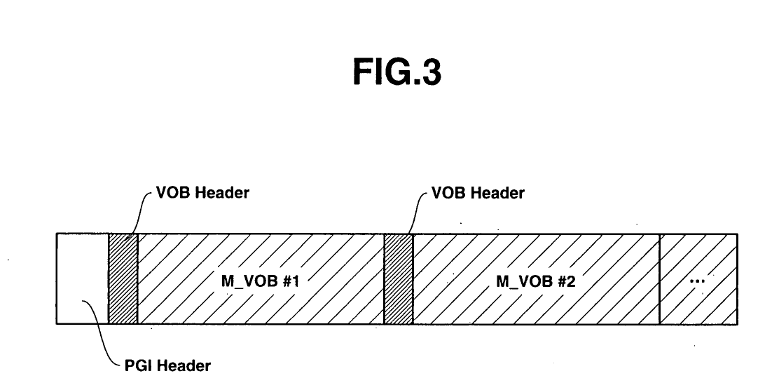

FIG. 3 shows a structure of an MPEG stream transmitted from an apparatus to a network via an Ethernet (trademark) controller, according to the embodiment.

To transmit an MPEG stream over a network, a program information header (PGI header) is added to the head of the stream and is transmitted. Subsequently, a VOB header is added to the head of every subsequent M_VOB forming a stream and is transmitted.

The PGI header contains information about, for example, the number of cells included in the stream. The VOB header contains PTM information, i.e., time information, and STI information, i.e., audio and video attribute information.

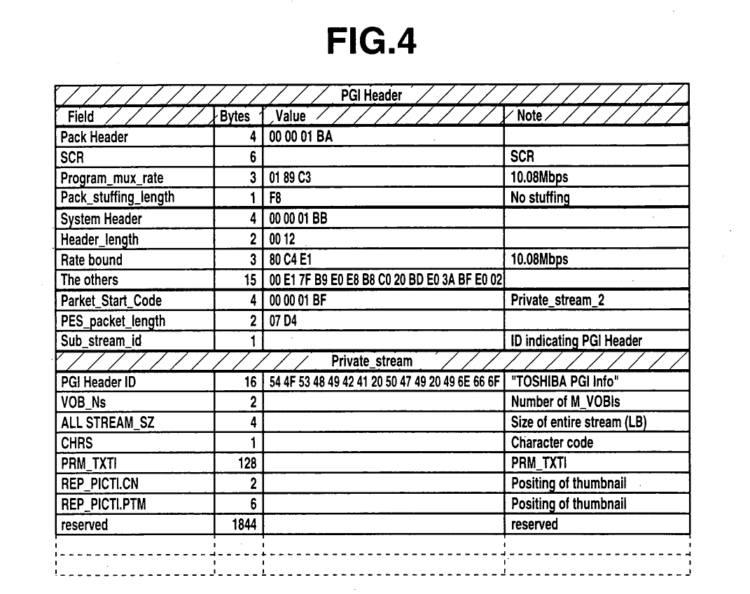

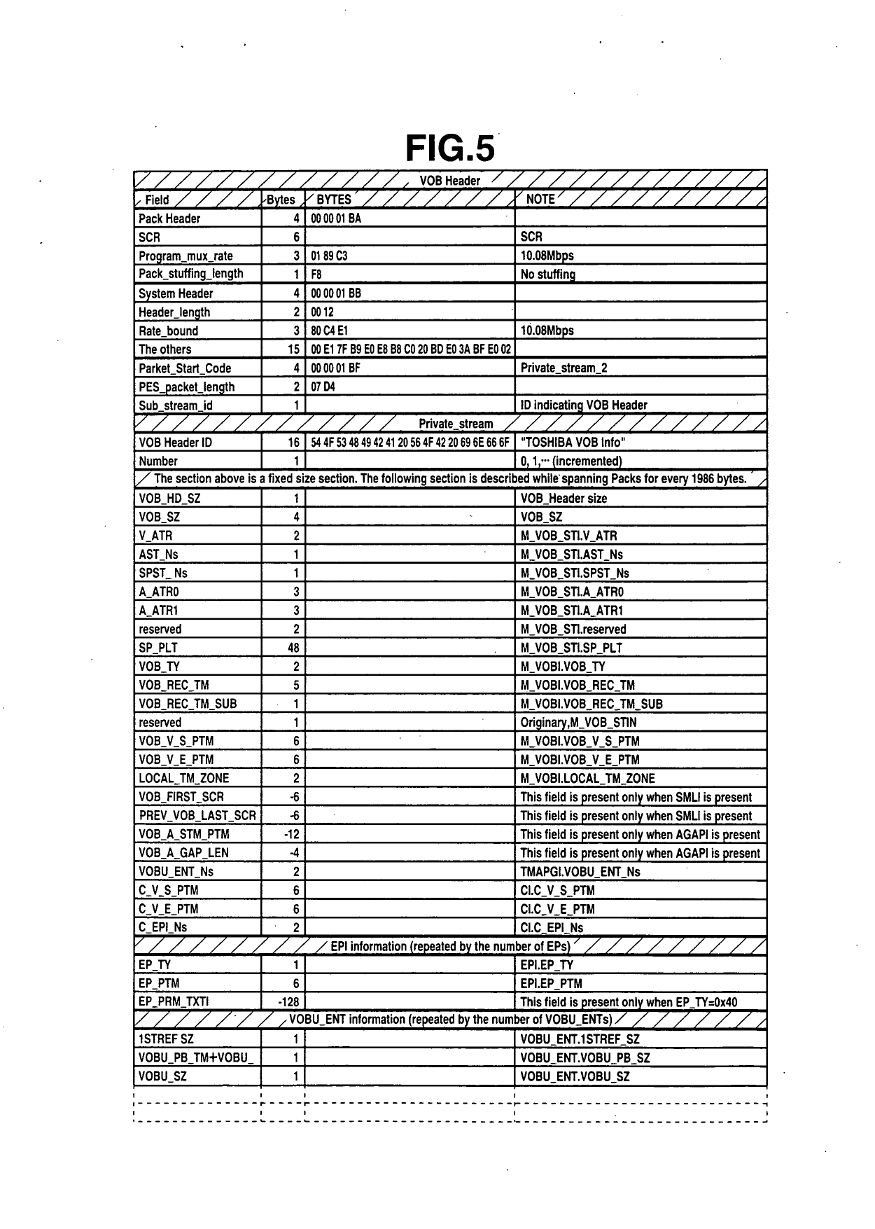

FIG. 4 is a diagram illustrating PGI header information (fields) of the transmitted stream shown in FIG. 3. FIG. 5 is a diagram illustrating VOB header information (fields) of the transmitted stream shown in FIG. 3.

According to the embodiment, the video recording and reproducing apparatus creates a PGI header, shown in FIG. 4, from content information stored in a hard disk or a DVD-RAM disk and transmits the PGI header as a head portion of a stream. The video recording and reproducing apparatus then creates a VOB header containing VOB and TMAP information, as shown in FIG. 5, for each M_VOB forming the stream, adds the VOB header to the front of the M_VOB, and transmits the M_VOB.

By transmitting a stream having such a structure, different video recording and reproducing apparatuses on the network can copy content to each other.

More specifically, the transmitting section of the video recording and reproducing apparatus including the microcomputer 114 and the Ethernet (trademark) controller 116 transmits content recorded in the DVD-VR format over the network on a program basis. In addition to an MPEG stream in the M_VOB, the transmitting section transmits the number of cells in the program as reference information. Subsequently, the transmitting section transmits reference information, which is at least VOBU_ENT information for all of the VOBUs in the M_VOB and both M_VOB_STI information and the start and end PTM information for the corresponding M_VOB. In addition, the transmitting section may transmit, for every cell in the program, a CI start and end PTM, SMLI and AGAPI information of the M_VOB, or both a CI start and end PTM and SMLI and AGAPI information of the M_VOB as the reference information. These reference information items will be described below.

A program to be transmitted has several cells. When the program is transmitted, the number of cells is first transmitted, and then the reference information corresponding to each cell is transmitted for all the cells. In the transmitted stream shown in FIG. 3, a PGI header contains reference information about the number of cells, while a VOB header contains reference information, such as PTM information (time information) and STI information (audio and video attribute information). A video recording and reproducing apparatus on the receiving side writes the reference information in the PGI header and the VOB header to a management information file on a disk and writes the MPEG stream of the M_VOB subsequent to the VOB header to an MPEG file on the disk. Thus, the program, i.e., the content in the DVD-VR format is recorded on the disk of the video recording and reproducing apparatus on the receiving side.

As described above, in order for a video recording and reproducing apparatus on the transmitting side to transmit an MPEG stream recorded in the DVD-VR format and to cause a video recording and reproducing apparatus on the receiving side to record or copy it, content in the DVD-VR format recorded in a disk of the video recording and reproducing apparatus on the transmitting side must be converted into the stream format shown in FIG. 3 and must be transmitted over the network. Then, the stream must be received by the video recording and reproducing apparatus on the receiving side and must be reconstructed in the DVD-VR format and must be recorded in the disk thereof.

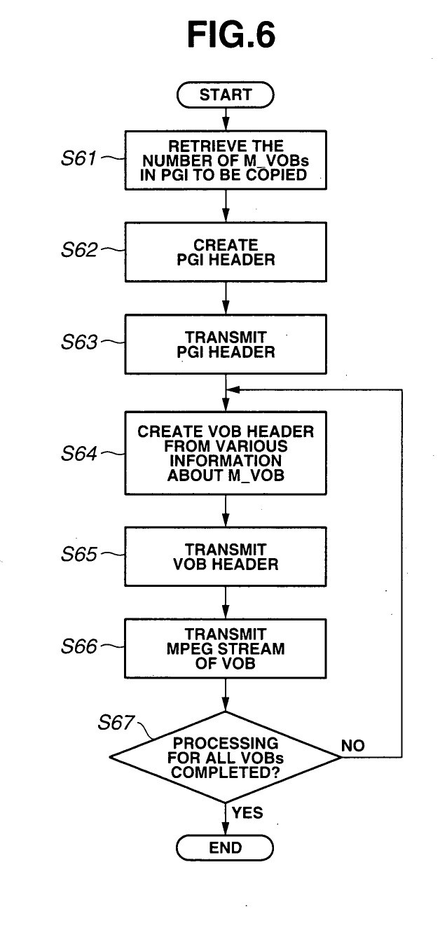

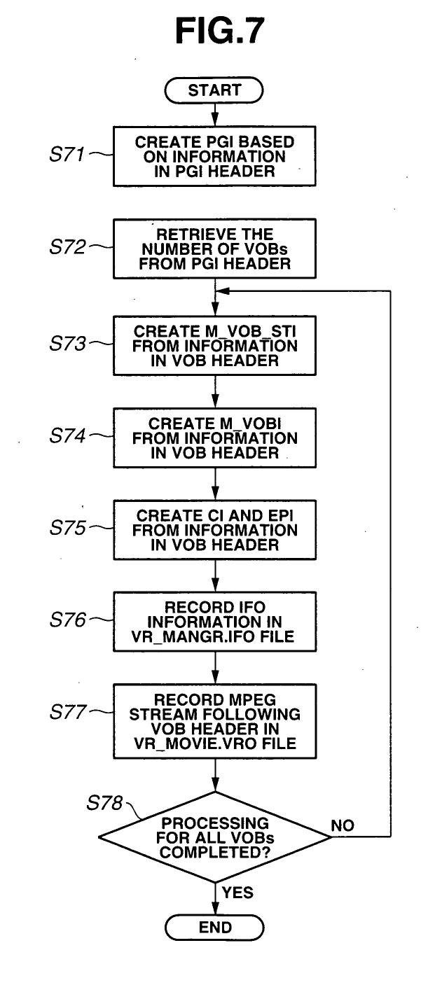

The conversion processes from the content in the DVD-VR format to the stream format shown in FIG. 3, and vice versa, will be described next with reference to FIGS. 6 and 7, respectively.

FIG. 6 is a flow chart of the conversion process of the content from the DVD-VR format to the stream format according to the present invention.

According to the flow chart, the number of M_VOBs, i.e., the number of CIs in a PGI of content to be copied is retrieved (step S61). Thereafter, a PGI header is created from content information stored in the HDD and the DVD-RAM (step S62). The PGI header is then transmitted (step S63).

Here, information required for content reconstruction in the PGI header shown in FIG. 4 is VOB_Ns information that indicates the number of M_VOBs. From the viewpoint of the transmitting process, ALL_STREAM_SZ, which indicates the total size of the stream, is also essential information. Other information is not mandatory. However, the PGI header is designed to allow useful information, such as a title name and positions of thumbnails, to be embedded. In this embodiment, these data are embedded in a private stream packet of the PGI header. The private stream packet is usable by the user.

Subsequently, a VOB header is created for each M_VOB from various types of information contained in the M_VOB (step S64). The VOB header is attached to the head of an MPEG stream of the M_VOB and is transmitted (steps S65 and S66). Thereafter, at step S67, it is determined whether the process is completed for all of the M_VOBs (step S67). If not, steps S64 through S67 are repeated until all of the M_VOBs are processed.

In the VOB header, mandatory information to be transmitted is the following three types:

(1) Information in M_VOB_STI: V_ATR, AST_Ns, SPST_Ns, A_ATR0, A_ATR1, and SP_PLT

These data are written to an M_VOB_STI, which is a table indicating audio and video attribute information of the M_VOB. The data indicates the content of the MPEG stream. If these data are not transmitted, a video recording and reproducing apparatus on the receiving side must analyze the MPEG stream while reading the entire MPEG stream to restore the information.

(2) Start and End PTM Information of M_VOB: VOB_V_S_PTM and VOB_V_E_PTM

These information include time stamps indicating a start time and an end time of the M_VOB. Like the above-described information, if these data are lost, a video recording and reproducing apparatus on the receiving side must analyze the MPEG stream while reading the entire MPEG stream to restore the information.

(3) Information Associated with VOBU_ENT: VOB_ENT_Ns, VOBU_ENT Information

These information are related to a VOBU among the TMAP information of the M_VOB. If these data are lost, a video recording and reproducing apparatus on the receiving side must analyze the MPEG stream while reading the entire MPEG stream to restore the information. The TM_ENT information among the TMAP information is not mandatory since the TM_ENT information can be computed from the VOBU_ENT information.

These three types of information (1) to (3) are essential for reconstructing the content of the DVD-VR format in the video recording and reproducing apparatus on the receiving side.

Additionally, if the following two types of information (4) and (5) are lost, the original content cannot be reconstructed completely.

(4) Start and End PTM Information of CI: C_V_S_PTM and C_V_E_PTM

In the DVD-VR format, an image may be deleted on a frame basis by an edit operation. This is because a CI which a M_VOB in the DVD-VR format references can indicate a start point and an end point of a frame or frames. If the information in the CI is lost, a start point and an end point of a frame or frames become unavailable, and therefore, a start point and an end point of a GOP or GOPs for the MPEG standard are used. This results in coarse positioning in the edit operation.

(5) Information Associated with Seamless Reproduction of the M_VOB: VOB_FIRST_SCR, PREV_VOB_LAST_SCR, VOB_A_STM_PTM, and VOB_A_GAP_LEN

This information is also referred to as SMLI and AGAPI information of M_VOB. SMLI stands for seamless information, which indicates time duration between videos, that is, a time duration between VOBs. In other words, the seamless information indicates how long a time gap exists between one VOB and the next VOB. This information allows smooth reproduction without stopping at a gap between video segments. AGAPI stands for audio gap information, which describes information about the time duration between audio segments.

That is, the above-described information (5) is required for seamless reproduction in which the reproduction is not paused at the boundaries between M_VOBs. Without this information, audio and video may temporarily stop, thus interrupting seamless reproduction.

The VOB header shown in FIG. 5 is designed to allow other information about an entry point.

Additionally, the reference information transmitted along with the MPEG stream is recorded in private_stream sections, defined by the MPEG standard, in the PGI and VOB headers shown in FIGS. 4 and 5. The private_stream will be described next. In general, when being recorded in a disk, MPEG data in the DVD-VR format is divided into two information items, that is, an audio and video MPEG stream and reference information thereof. These two types of data are separately recorded in dedicated files. In the transmission stream format over a network, as shown in FIG. 3, an MPEG stream portion consists of a series of 2048-byte packs or blocks. The pack has different types, such as an audio pack and a video pack. A packet start code indicates the type of the pack. For example, a pack having a packet start code “000001E0” is a video packet. An MPEG decoder sends this packet to an internal video decoder. In contrast, there is only one type of private_stream packet. However, the private_stream is neither a video packet nor an audio packet. The private_stream may be used by a user. An ordinary personal computer (PC) cannot reproduce the private_stream and, therefore, discards it.

Accordingly, MPEG reproducing software running on a PC ignores the private_streams in the PCI header and the VOB header, and can reproduce only an MPEG stream portion. That is, since the PC skips reading of the private_stream, the PC can reproduce the MPEG stream portion.

FIG. 7 is a flow chart for a video recording and reproducing apparatus that receives the transmitted stream shown in FIG. 3 to reconstruct the content in the DVR-VR format from the transmitted stream, according to the present invention.

A PGI header and a VOB header of a stream from a video recording and reproducing apparatus on the transmitting side contains content information (PG₁, M_VOBI, CI, and EPI), which is to be written to a “VR_MANGR.IFO” IFO file in a disk of a video recording and reproducing apparatus on the receiving side. Therefore, this information (PGI, M_VOBI, CI, and EPI) is retrieved from the PGI header and the VOB header of the stream to create IFO information, which is recorded in the “VR_MANGR.IFO” IFO file in a disk of the video recording and reproducing apparatus on the receiving side. Subsequently, an MPEG stream following the VOB header is recorded in a “VR_MOVIE.VRO” VRO file in the disk.

First, a PGI is created from information in the PGI header of the stream (step S71). In addition, the number of M_VOBs is retrieved from the PGI header (step S72). Then, a M_VOB_STI is created from information in the VOB header of the stream (step S73). Additionally, an M_VOBI is created from the information in the VOB header (step S74). Furthermore, a CI and an EPI are created from the information in the VOB header (step S75). IFO information created or retrieved from the PGI header and the VOB header is recorded in the VR_MANGR.IFO file (step S76). The MPEG stream of the M_VOB following the VOB header is then recorded in the VR_MOVIE.VRO file (step S77). The process then proceeds to step S78. At step S78, it is determined whether creating IFO information from a VOB header, recording the IFO information for all of the M_VOBs, and recording MPEG data for all of the M_VOBs are completed.

Steps S73 through S78 are repeated until IFO information created from the VOB header, i.e., the M_VOB_ST₁, M_VOBI, CI, and EPI, are created and recorded in the VR_MANGR.IFO file for all of the M_VOBs. Also, Steps S73 through S78 are repeated until the MPEG data of MPEG stream represented by the M_VOB is recorded in the VR_MOVIE.VRO file for all of the M_VOBs.

This procedure allows the content in the DVD-VR format to be reconstructed from the transmitted stream shown in FIG. 3.

In the known technologies, the reference information (i.e., IFO information) associated with an MPEG stream can be recorded only within a single apparatus. According to the present invention, by transmitting reference information of a stream format shown in FIG. 3 along with an MPEG stream over a network, content can be transmitted and received, over the network, among a plurality of apparatuses. Additionally, to permit a PC on the network to show the content, the above-described information is embedded as a private_stream of the MPEG. Thus, even software, such as Windows Media Player (trademark), that pre-reads the head portion of a stream to determine a data type can reproduce MPEG stream data containing audio and video data by discarding the private_stream containing the reference information (IFO information). In addition, the reference information including meaningful information, e.g., special-reproducing information, specified by a user of a video recording and reproducing apparatus on the transmitting side is stored in a disk of a video recording and reproducing apparatus on the receiving side in association with an MPEG stream in accordance with the DVD-VR format. Accordingly, an MPEG decoder in the video recording and reproducing apparatus on the receiving side can reproduce the stream just as the user on the transmitting side intended. That is, in the video recording and reproducing apparatus on the receiving side, inconsistency between reference information and an MPEG stream is eliminated so that both reference information and the MPEG stream are recorded while the reference information properly corresponds to the MPEG stream in accordance with the DVD-VR format.

According to the present invention, in a video recording and reproducing apparatus having a communications function via a network and a recording and reproducing function in a predetermined format, e.g., the DVD-VR format, content can be transmitted and received over the network among a plurality of apparatuses. Consequently, a content transmitting apparatus, a content receiving apparatus, and a content transmitting and receiving system having a function of transmitting and receiving content over a network and a function of recording and reproducing the content can be achieved.

Having described the preferred embodiments of the invention referring to the accompanying drawings, it should be understood that the present invention is not limited to those precise embodiments, and various changes and modifications thereof could be made by one skilled in the art without departing from the spirit or scope of the invention as defined in the appended claims.

1. A content transmitting apparatus comprising:
a section for supplying video and audio content;
a section for encoding the supplied content into MPEG data;
a section for dividing the MPEG data into an MPEG stream and reference information thereof and recording the MPEG stream and the reference information in a recording medium in the DVD-VR format; and
a transmitting section for transmitting the content in the DVD-VR format via a network, the transmitting section transmitting the MPEG stream in an M_VOB and reference information of the MPEG stream, the reference information comprising VOBU_ENT information for all VOBUs contained in the M_VOB, M_VOB_STI information of the M_VOB, and start and end PTM information of the M_VOB.

2. The content transmitting apparatus according to claim 1, wherein the transmitting section further transmits reference information comprising one of CI start and end PTMs, SMLI and AGAPI information of the M_VOB, and both of the CI start and end PTMs and the SMLI and AGAPI information of the M_VOB in addition to the VOBU_ENT information for all VOBUs contained in the M_VOB, the M_VOB_STI information of the M_VOB, and the start and end PTM information of the M_VOB.

3. The content transmitting apparatus according to claim 1, wherein the transmitting section transmits the content recorded in the DVD-VR format via a network on a program basis, the transmitting section transmits the number of cells in the program as one reference information, then transmits another reference information for every cell, and the latter reference information associated with each cell comprises the VOBU_ENT information for all VOBUs contained in the M_VOB, the M_VOB_STI information of the M_VOB, and the start and end PTM information of the M_VOB.

4. The content transmitting apparatus according to claim 1, wherein the transmitting section transmits the content in the DVD-VR format via a network on a program basis, the transmitting section transmits the number of cells in the program as one reference information, then transmits another reference information for every cell, and the latter reference information associated with each cell comprises the VOBU_ENT information for all VOBUs contained in the M_VOB, the M_VOB_STI information of the M_VOB, and the start and end PTM information of the M_VOB, and one of CI start and end PTMs, SMLI and AGAPI information of the M_VOB, and both of the CI start and end PTMs and the SMLI and AGAPI information of the M_VOB.

5. The content transmitting apparatus according to claim 1, wherein the transmitting section adds the reference information to the head of the MPEG stream in the M_VOB as a private_stream defined by the MPEG standard and transmits the MPEG stream, and the reference information comprises the VOBU_ENT information for all VOBUs contained in the M_VOB, the M_VOB_STI information of the M_VOB, and the start and end PTM information of the M_VOB.

6. The content transmitting apparatus according to claim 3, wherein the transmitting section adds the reference information to the head of the MPEG stream in an M_VOB as a private_stream defined by the MPEG standard and transmits the MPEG stream, and the reference information comprises the number of cells, the VOBU_ENT information for all VOBUs contained in the M_VOB, the M_VOB_STI information of the M_VOB, and the start and end PTM information of the M_VOB.

7. The content transmitting apparatus according to claim 4, wherein the transmitting section adds the reference information to the head of the MPEG stream in the M_VOB as a private_stream defined by the MPEG standard and transmits the MPEG stream, and the reference information comprises the number of cells, the VOBU_ENT information for all VOBUs contained in the M_VOB, the M_VOB_STI information of the M_VOB, the start and end PTM information of the M_VOB, and one of the CI start and end PTMs, the SMLI and AGAPI information of the M_VOB, and both of the CI start and end PTMs and the SMLI and AGAPI information of the M_VOB.

8. A content receiving apparatus for receiving a stream transmitted by the content transmitting apparatus according to claim 1, the content receiving apparatus comprising:
a receiving section for receiving the transmitted stream via a network; and
a section for reconstructing content in the DVD-VR format from the received stream and recording the content in a recording medium;
wherein an MPEG stream in an M_VOB of the received stream is recorded in a VRO data file, IFO information is created from reference information in the received stream and is recorded in an IFO file, and the reference information comprises VOBU_ENT information for all VOBUs contained in the M_VOB, M_VOB_STI information of the M_VOB, and start and end PTM information of the M_VOB.

9. A content receiving apparatus for receiving a stream transmitted by the content transmitting apparatus according to claim 3, the content receiving apparatus comprising:
a receiving section for receiving the transmitted stream via a network; and
a section for reconstructing content in the DVD-VR format from the received stream and recording the content in a recording medium;
wherein an MPEG stream in an M_VOB of the received stream is recorded in a VRO data file, IFO information is created from reference information in the received stream and is recorded in an IFO file, and the reference information comprises the number of cells in the received stream, VOBU_ENT information for all VOBUs contained in the M_VOB, M_VOB_STI information of the M_VOB, and start and end PTM information of the M_VOB.

10. A content receiving apparatus for receiving a stream transmitted by the content transmitting apparatus according to claim 4, the content receiving apparatus comprising:
a receiving section for receiving the transmitted stream via a network; and
a section for reconstructing content in the DVD-VR format from the received stream and recording the content in a recording medium;
wherein an MPEG stream in the M_VOB of the received stream is recorded in a VRO data file, IFO information is created from reference information in the received stream and is recorded in an IFO file, and the reference information comprises the number of cells in the received stream, the VOBU_ENT information for all VOBUs contained in the M_VOB, the M_VOB_STI information of the M_VOB, the start and end PTM information of the M_VOB, and one of the CI start and end PTMs, the SMLI and AGAPI information of the M_VOB, and both of the CI start and end PTMs and the SMLI and AGAPI information of the M_VOB.

11. A content transmitting and receiving system comprising a content transmitting apparatus and a content receiving apparatus, the content transmitting apparatus comprising:
a section for supplying video and audio content;
a section for encoding the supplied content into MPEG data;
a section for dividing the MPEG data into an MPEG stream and reference information thereof and recording the MPEG stream and the reference information in a recording medium in the DVD-VR format; and
a transmitting section for transmitting the content recorded in the DVD-VR format via a network, the transmitting section transmitting the MPEG stream in an M_VOB and reference information of the MPEG stream, the reference information comprising VOBU_ENT information for all VOBUs contained in the M_VOB, M_VOB_STI information of the M_VOB, and start and end PTM information of the M_VOB, and
the content receiving apparatus comprising:
a receiving section for receiving a stream transmitted by the content transmitting apparatus via a network; and
a section for reconstructing the content in the DVD-VR format from the received stream and recording the content in a recording medium;
wherein an MPEG stream in the received stream in the M_VOB is recorded in a VRO data file, and IFO information is created from the reference information in the received stream and is recorded in an IFO file.

12. A content transmitting method comprising:
a step for supplying video and audio content;
a step for encoding the supplied content into MPEG data;
a step for dividing the MPEG data into an MPEG stream and reference information thereof and recording the MPEG stream and the reference information in a recording medium in the DVD-VR format; and
a step for transmitting the content recorded in the DVD-VR format via a network, the transmitting step transmitting the MPEG stream in an M_VOB and reference information of the MPEG stream, the reference information comprising VOBU_ENT information for all VOBUs contained in the M_VOB, M_VOB_STI information of the M_VOB, and start and end PTM information of the M_VOB.

13. The content transmitting method according to claim 12, wherein the transmitting step transmits the content in the DVD-VR format via a network on a program basis, the transmitting step transmits the number of cells in the program over the network as one reference information, then transmits another reference information for every cell, and the latter reference information associated with each cell comprises the VOBU_ENT information for all VOBUs contained in the M_VOB, the M_VOB_STI information of the M_VOB, and the start and end PTM information of the M_VOB.

14. A content receiving method for receiving a stream transmitted by the transmitting method according to claim 12, the content receiving method comprising:
a step for receiving the transmitted stream via a network; and
a step for recording, in a recording medium, a reconstructed stream as content in the DVD-VR format;
wherein an MPEG stream in the M_VOB of the received stream is recorded in a VRO data file, IFO information is created from reference information in the received stream and is recorded in an IFO file, and the reference information comprises VOBU_ENT information for all VOBUs contained in the M_VOB, M_VOB STI information of the M_VOB, and start and end PTM information of the M_VOB.

15. A content receiving method for receiving a stream transmitted by the transmitting method according to claim 13, the content receiving method comprising:
a step for receiving the transmitted stream via a network; and
a step for recording, in a recording medium, a reconstructed stream as content in the DVD-VR format;
wherein an MPEG stream in the M_VOB of the received stream is recorded in a VRO data file, IFO information is created from reference information in the received stream and is recorded in an IFO file, and the reference information comprises the number of cells in the received stream, VOBU_ENT information for all VOBUs contained in the M_VOB, M_VOB_STI information of the M_VOB, and start and end PTM information of the M_VOB.
